(19) United States
(12) Patent Application Publication
(10) Pub. No.: US 2022/0298937 A1
(43) Pub. Date: Sep. 22, 2022

(54) BLOW-BY GAS FILTRATION ASSEMBLY WITH BLOCKING INSERT

(71) Applicant: UFI FILTERS S.P.A., Porto Mantovano, Mantova (IT)

(72) Inventor: Giorgio GIRONDI, Porto Mantovano, Mantova (IT)

(21) Appl. No.: 17/632,656

(22) PCT Filed: Jul. 31, 2020
(86) PCT No.: PCT/IB2020/057250

§ 371 Date: Feb. 3, 2022

(30) Foreign Application Priority Data
Aug. 7, 2019 (IT) 102019000014268

(51) Int. Cl. F01M 13/04; B01D 46/00; B01D 46/44; B01D 46/24

(52) U.S. Cl. CPC F01M 13/04; B01D 46/0056; B01D 46/44; B01D 46/2411; F01M 2013/0438; B01D 2265/029; B01D 2271/022

(57) ABSTRACT

A blow-by gas filtration assembly fluidically connects to a crankcase ventilation circuit of an internal combustion engine. The filtration assembly has an axis and includes a filter group having a hollow cylindrical shape with a central chamber radially traversable by the blow-by gases, preferably from the outside to the inside. In addition, the filtration assembly includes a support and control member engageable to the filter group for supporting it in an axial position along the axis and for controlling it in rotation around the axis to perform the filtration operations. The member and the filter group respectively include a locking crown and a locking ring specially shaped to accommodate each other. The blow-by gas filtration assembly also includes a locking insert insertable radially with respect to the axis through the locking crown and the locking ring to perform reciprocal locking of the filter group to the member.

### FIELD OF APPLICATION

The present invention relates to a blow-by gas filtration assembly.

In particular, the blow-by gas filtration assembly of the present invention is fluidly connectable to the crankcase ventilation circuit of an internal combustion engine system inside of a vehicle to receive blow-by gases (from said crankcase) and filter from them the suspended particles contained therein.

Specifically, “blow-by gas” means oil vapours vented from the crankcase of an internal combustion engine during its operation. In particular, said blow-by gases have a composition similar to that of exhaust gases and are generated by combustion of the air/fuel mixture in the combustion chamber. Instead of reaching the exhaust gas emission circuit, these gases leak into the lower portion of the crankcase, passing alongside the cylinders and bringing carbon particles and oil drops with them. In the present discussion, for the sake of simplicity, blow-by gases are considered to consist of air and suspended particles; said suspended particles comprise oil droplets and/or carbonaceous particulates.

### STATE OF THE ART

In the state of the art, solutions of filtration assemblies that is fluidly connectable to the crankcase and suitable for venting it from blow-by gases are known of.

Specifically, blow-by gas filtration assembly solutions which separate unwanted suspended particles from the aforesaid blow-by gases are known of, comprising a filter group having such purpose.

In the state of the art, a plurality of embodiments of filtration assemblies comprising a filter group comprising a porous-type filter medium, driven in rotation by a specially shaped support and control member such that the suspended particles are separated from the air both by passing through the porous material and by the action of the centrifugal force, are known of.

In fact, solutions are known in the state of the art in which said support and control member comprises a control drive of the mechanical type, for example connected to a rotating element of the vehicle, such as the camshaft of the engine, or of the electrical type comprising a specific electric motor.

Such embodiments typically have a complex shape especially in the connection methods between the filter group and the control member. In particular, such embodiments have a complex coupling of the two components (or groups of components): this involves particularly complex assembly (and disassembly) operations and involves a certain risk of angular misalignment in the rotational operations of the filter group.

### Solution According to the Invention

In the aforesaid state of the art the need is therefore strongly felt to have a blow-by gas filtration assembly that solves the aforesaid problem, being simple in shape and above all having simple reciprocal coupling methods of the filter group and support and control member.

The purpose of the present invention is to provide a new embodiment of a blow-by gas filtration assembly which satisfies said requirement.

Such purpose is achieved by the blow-by gas filtration assembly claimed in claim 1. The dependent claims show preferred embodiment variants having further advantageous aspects.

### DESCRIPTION OF THE DRAWINGS

Further characteristics and advantages of the invention will, in any case, be evident from the description given below of its preferred embodiments, made by way of a non-limiting example with reference to the appended drawings, wherein:

FIG. 1a shows a perspective view in separate parts of the blow-by gas filtration assembly according to the present invention, according to a preferred embodiment;

FIG. 1b shows a cross-section view of the blow-by gas filtration assembly as in FIG. 1a, assembled;

FIG. 2 shows a perspective view in separate parts of some components of the blow-by gas filtration assembly in FIG. 1a;

FIG. 3 shows a side view in longitudinal cross-section of FIG. 2;

FIG. 3a shows a cross-section view of the components as in FIG. 3, reciprocally assembled;

FIG. 4a shows a perspective view in separate parts of the blow-by gas filtration assembly according to the present invention, according to a further preferred embodiment;

FIG. 4b shows a cross-section view of the blow-by gas filtration assembly as in FIG. 4a, assembled;

FIG. 5 shows a perspective view in separate parts of some components of the blow-by gas filtration assembly in FIG. 4a;

FIG. 6 shows a side view in longitudinal cross-section of FIG. 5;

FIG. 6a shows a cross-section view of the components as in FIG. 6, reciprocally assembled.

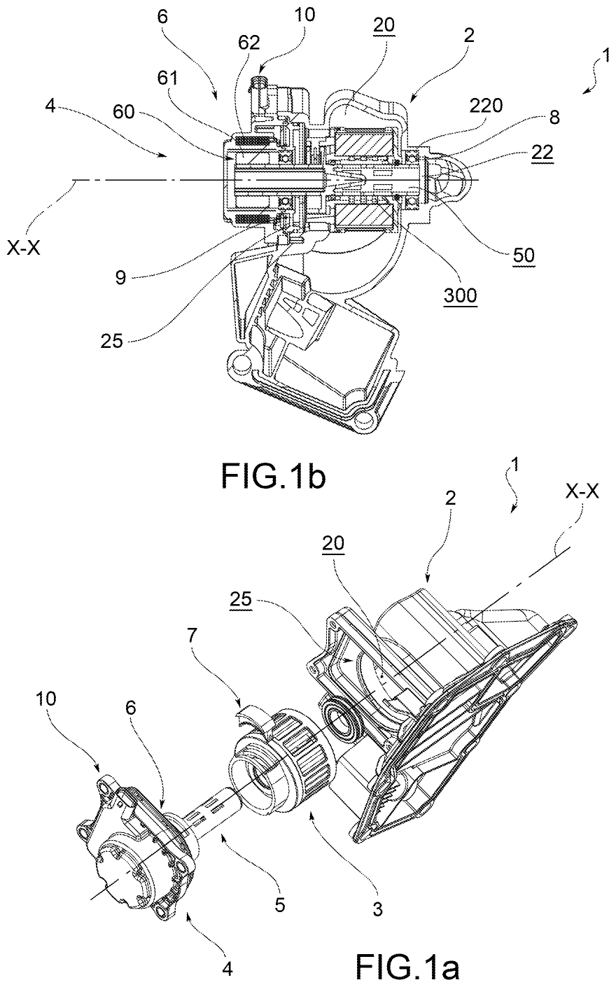

### DETAILED DESCRIPTION

With reference to the appended drawings, reference numeral 1 denotes a blow-by gas filtration assembly suitable for performing a filtration/separation action on particles (liquid and/or solid) suspended in the gas stream.

Said blow-by gas filtration assembly 1 is fluidly connectable to a crankcase ventilation circuit of an internal combustion engine of a vehicle to receive blow-by gases and filter from them he suspended particles contained therein returning a stream of clean gas (i.e. filtered) to other vehicle systems such as, for example, to the engine air intake circuit communicating with the combustion chamber of the internal combustion engine.

Preferably, said blow-by gas filtration assembly 1 is directly mountable to the crankcase of an internal combustion engine of a vehicle. In particular, the present invention is not limited to this feature; the blow-by gas filtration assembly 1 could be configured as a stand-alone device comprising respective inlet and outlet ports communicating respectively with the crankcase, for receiving blow-by gases to be filtered, and with the air intake circuit, for recirculating the gas stream filtered of solid and liquid particles towards the combustion chamber.

According to the present invention, the filtration assembly 1 comprises an X-X axis with respect to which the components described below extend or are positioned.

According to a preferred embodiment, the blow-by gas filtration assembly 1 comprises a main body 2.

Preferably, the other components of the system are positioned in or on said main body 2, as described extensively below and evident from the exemplary figures attached below.

In particular, the main body 2 comprises a filtration chamber 20 in which filtration/separation operations of the blow-by gases take place. The filtration chamber 20 is therefore fluidically connected to the crankcase ventilation circuit of an internal combustion engine of a vehicle to receive dirty blow-by gases, i.e. comprising suspended particles (solid and/or liquid), and to the engine air intake system to re-introduce clean blow-by gases, i.e. cleaned of the suspended particles, into said system.

According to a preferred embodiment, the main body 2 comprises respective blow-by gas inlets and outlets.

Preferably, the main body 2 comprises an inlet mouth fluidically connected with the crankcase ventilation circuit of a vehicle to receive the blow-by gases to be filtered. Preferably, said inlet mouth is made substantially parallel to the X-X axis spaced therefrom. Preferably, said inlet mouth is made on the side wall of the main body 2. Preferably, said inlet mouth is made on the wall of the main body 2 defining the filtration chamber 20.

Moreover, the main body 2 comprises an outlet mouth 22. Preferably, said outlet mouth 22 is made positioned on the X-X axis. Preferably, the outlet mouth 22 is perpendicular to said X-X axis. Preferably, the outlet mouth 22 is coaxial to the X-X axis.

The outlet mouth 22 is bounded laterally, annularly, by an outlet edge 220.

According to a preferred embodiment, from the outlet mouth 22, the main body 2 provides for an outlet connection that interfaces with the engine air intake circuit communicating with the combustion chamber of the internal combustion engine of a vehicle. According to a preferred embodiment, said outlet connection communicates with an outlet opening made on the coupling flange of the main body 2 to the internal combustion engine crankcase.

According to a preferred embodiment, moreover, the main body 2 comprises an assembly opening 25 through which the components described below is insertable inside the main body 2, preferably inside the filtration chamber 20. Preferably, said assembly opening 25 is made in a position opposite the outlet mouth 22. Preferably, the assembly opening 25 is made along the X-X axis having its extension (orientation) transverse to the X-X axis, preferably a perpendicular extension.

According to the present invention, the blow-by gas filtration assembly 1 comprises a filter group 3, specifically suitable for performing said filtration/separation operations of the particles suspended in the blow-by gases. Said filter group 3 is positionable and operates in the filtration chamber 20.

The filter group 3 extends along the X-X axis having a hollow cylindrical shape, comprising, in fact, a central chamber 300.

The filter group 3 can be crossed radially by blow-by gases. Preferably, the filter group 3 can be crossed by blow-by gases in a radial direction from the outside towards the inside.

Preferably, the inlet mouth is radially facing the filter group 3. According to a preferred embodiment, the inlet mouth is radially facing the outer surface of the filter group 3.

Preferably, said outlet mouth 22 is axially facing the central chamber 300.

In other words, the filter group 3 identifies, in the filtration chamber 20, a dirty side in which there are blow-by gases to filter and a clean side in which there are filtered blow-by gases. Preferably, the outlet mouth 22 is fluidly connected with said clean side.

According to a preferred embodiment, the central chamber 300 of the filter group surrounds the clean side in which the filtered blow-by gases are present and fluidly communicates with the outlet mouth 22.

According to a preferred embodiment, the filter group 3 comprises a filter medium 30. The filter medium 30, which can be crossed radially comprises a non-woven fabric pleated in the form of a star or a porous cylindrical septum.

Moreover, according to a preferred embodiment, the filter group 3 comprises a first filter plate 31 and a second filter plate 32 mutually arranged at the ends of the filter medium 30.

Preferably, the filter group 3 comprises a first filter plate 31 and a second plate 32 reciprocally engaged to the ends of the filter medium 30.

In addition, according to a preferred embodiment, the filter group 3 comprises a central structure 33 which is housed inside the filter medium 30 and joins the two filter plates 31, 32, so that the filter plates 31, 32 are integrally connected in rotation. Preferably, said central structure 33 has one or more through openings suitable to allow the passage of the fluid being filtered.

According to a preferred embodiment said central structure 33 is made in one piece with the first filter plate 31. In addition, according to a preferred embodiment, the filter group 3 comprises an outer structure 34 which surrounds the filter medium 30 on the outside and joins the two filter plates 31, 32. Preferably, said outer structure 34 has a plurality of through openings suitable to allow the passage of the fluid being filtered.

According to a preferred embodiment said central structure 33 is made in one piece with the second filter plate 32.

According to a preferred embodiment, said central structure 33 is a tubular body with one or more through openings engaging the filter plates 31, 32.

As shown in the attached figures, the central chamber 300 extends through the filter plates 31, 32 surrounded by the filter medium 30. According to a preferred embodiment, the central chamber 300 extends through respective through openings 318, 328 made on the filter plates 31, 32. Preferably, said openings 318, 328 are concentric to the X-X axis, like the central chamber 300.

According to the present invention, moreover, the filtration assembly 1 comprises a support and control member 4 engageable to the filter group 3 suitable for supporting it in an axial position along the X-X axis and suitable for controlling it in rotation around said X-X axis to perform the filtration operations.

In other words, said support and control member 4 is a component or group of components suitable for receiving or producing a rotational action on the filter group 3 to guide it in rotation.

According to a preferred embodiment, said support and control member 4 comprises a control drive 6 operatively connected to the filter group 3 to command it in rotation about the X-X axis.

Preferably, said control drive 6 is of the electrical type or of the mechanical type or of the electromechanical type.

According to a preferred embodiment, the control drive 6 is connected to external groups comprised in the vehicle, e.g. the camshaft.

According to a further preferred embodiment, the control drive 6 comprises an electric motor group 60 comprising a rotor 61 and a stator 62. The electromagnetic actuation of the stator 62 entails the rotation of the rotor 61 about the X-X axis. According to a preferred embodiment, the electric motor group 60 is of the electrical type, preferably brushless.

According to a preferred embodiment, the rotor 61 comprises one or more elements in ferromagnetic material arranged in the shape of a toroid.

Preferably, in addition, the support and control member 4 comprises a closing cover 10 fitted tight on the main body 2. Preferably, the closing cover 10 sealingly engages the main body 2 to close an assembly opening 25, provided on said main body. Preferably, said closing cover 10 supports said electric motor group 60. Preferably, the closing cover 10 is mountable in an axial direction to the main body 2. Preferably, the closing cover is secured to the main body 2 by means of screws with bushing or self-tapping screws.

According to a preferred embodiment, the electric motor group 60 comprises an electronic board housed on the closing cover 10. Said electronic board is electrically connected to the vehicle control unit by means of an electrical connector integrated on the closing cover 10.

According to the present invention, the member 4 and the filter group 3 respectively comprise a blocking crown 510 and a blocking ring 310 specially shaped to accommodate each other.

Furthermore, again according to the present invention, the blow-by gas filtration assembly 1 comprises a blocking insert 7 insertable radially with respect to the X-X axis through the blocking crown 510 and the blocking ring 310 to perform reciprocal blocking of the filter group 3 to the member 4.

In other words, the member 4 and the filter group 3 are reciprocally connected rotationally by means of said insert 7.

In other words, the engagement between the blocking crown 510 and the blocking ring 310 by means of the insert 7 determines the “integral” coupling between the two components so that the control member 4 and the filter group 3 are mechanically connected (“integrally”) to rotate in unison (or synchronously).

According to a preferred embodiment, the support and control member 4 comprises a shaft 5.

Such shaft 5 is a hollow body extending along the X-X axis and is specially designed to be operatively connected to the filter group 3 and the control drive 6.

Preferably, the shaft 5 is a hollow body made as a single component.

According to an alternative embodiment, the shaft is a hollow body composed of two or more parts mechanically couplable to each other (e.g. by welding, mechanical couplings, screws or the like) reversibly or irreversibly so as to form a single component the constituent parts of which rotate synchronously upon command by the control drive 6.

The shaft 5 in fact comprises a control portion 56 engaged to the control drive 6 and a filter portion 53 engaged to the filter group 3.

The shaft 5 in fact comprises a control portion 56 engaged to the control drive 6 and a filter portion 53 on which the filter group 3 is housed.

Preferably, said rotor 61 is housed on the control portion 56. In particular, the rotor 61 and the filter group 3 are mounted integrally to the shaft 5 respectively to the control portion 56 and to the filter portion 53 in such a way that a controlled rotation of the rotor 61 corresponds to a rotation of the shaft 5 and thus of the filter group 3. In particular, in the present description, “integrally” means that the control drive 6 and the filter group 3 are mechanically connected to the shaft 5 to rotate in unison (or synchronously).

According to a preferred embodiment, therefore, the blocking crown 510 is made on said shaft 5.

According to a preferred embodiment, the filter group 3 is specially shaped to house said blocking crown 510.

Preferably, the blocking crown 510 is positioned radially distal to the X-X axis and the blocking ring 310 is positioned in a complementary manner to engage and house said blocking crown 510.

Preferably, therefore, as shown in the drawings provided by way of example, the insert 7 radially crosses first the blocking ring 310 and then the blocking crown 510.

According to an alternative embodiment, the blocking crown 510 is positioned radially distal to the X-X axis and the blocking ring 310 is positioned in a complementary manner to engage said blocking crown 510 and remain housed inside said blocking crown 510.

Preferably, therefore, in such preferred embodiment, the insert 7 radially crosses the blocking crown 510 first and then the blocking ring 310.

According to a preferred embodiment, the blocking crown 510 comprises a crown window 511 and the blocking ring 310 comprises a ring window 311. The insert 7 is specially shaped to extend through said windows (positioned angularly aligned with each other).

According to a preferred embodiment, the blocking insert 7 is snap-blockable.

Preferably, the blocking insert 7 is snap-blockable to the blocking crown 510.

According to a preferred embodiment, the blocking insert 7 comprises at least two elastically yielding teeth 71 suitable for engaging the crown window walls 511.

Preferably, the elastically yielding teeth 71 are reciprocally arranged so as to be and act in two axially opposite directions to each other. Each tooth thus operates in a respective direction parallel to the X-X axis.

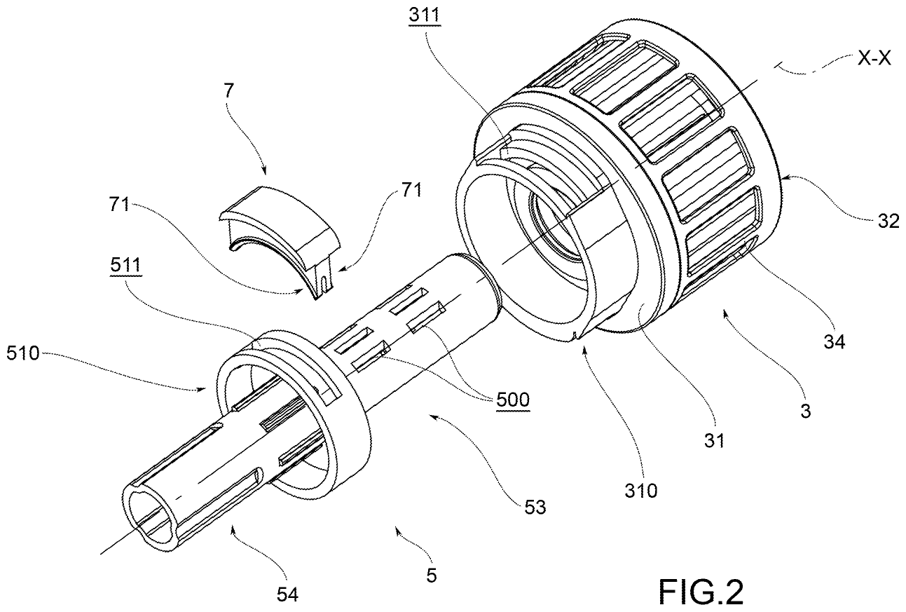

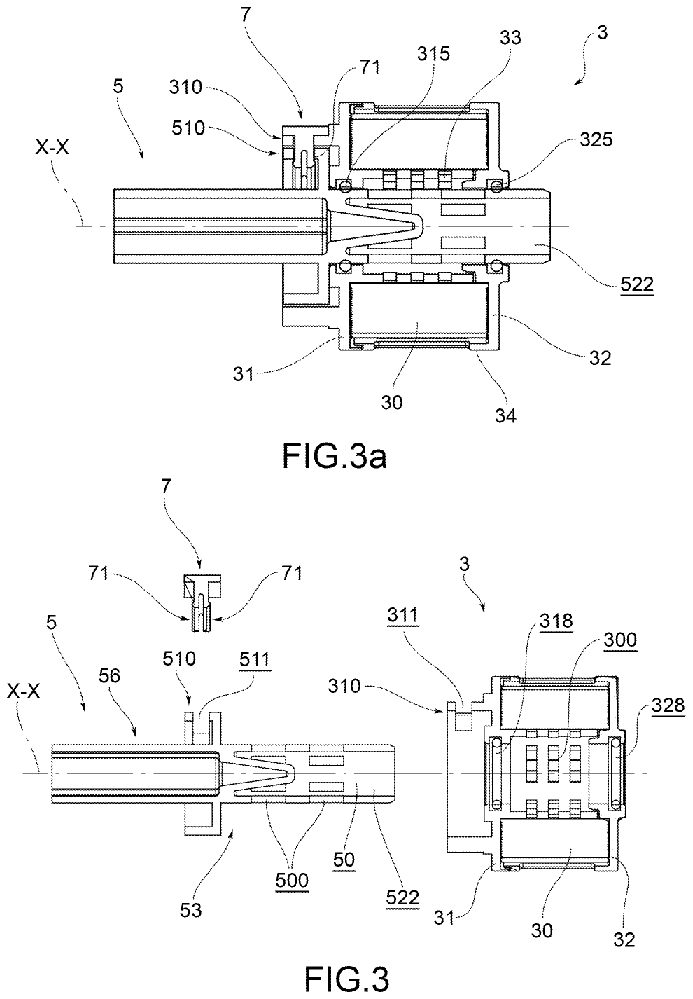

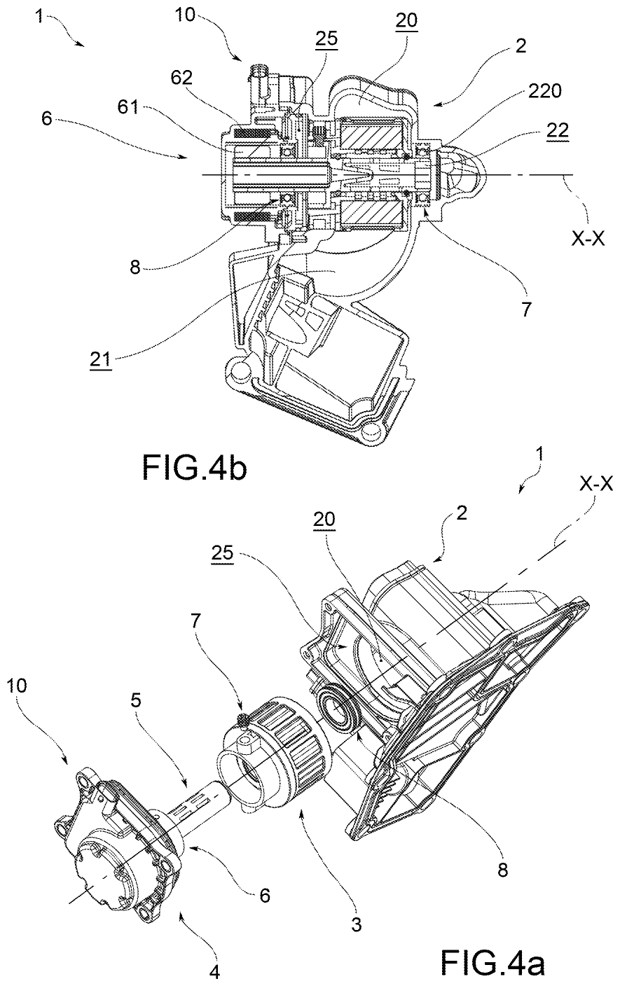

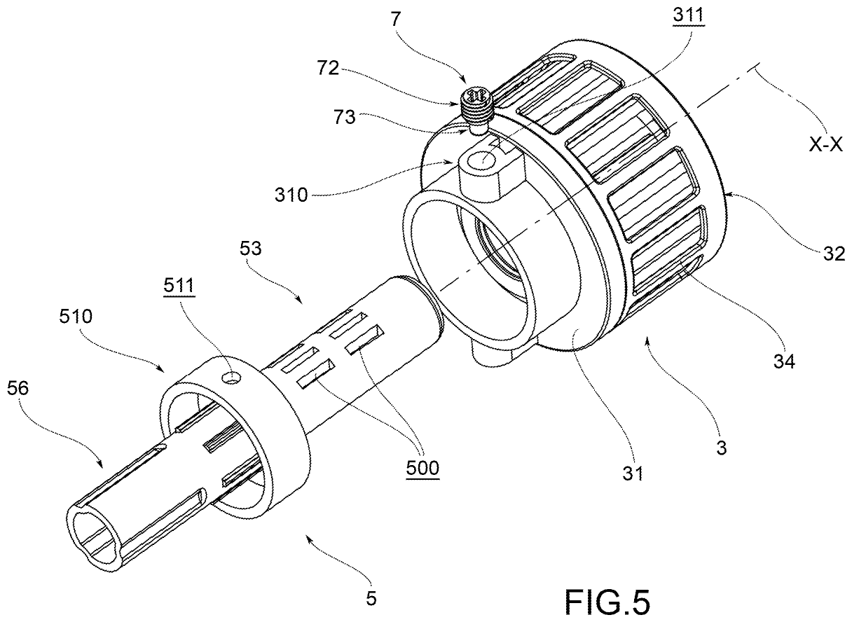

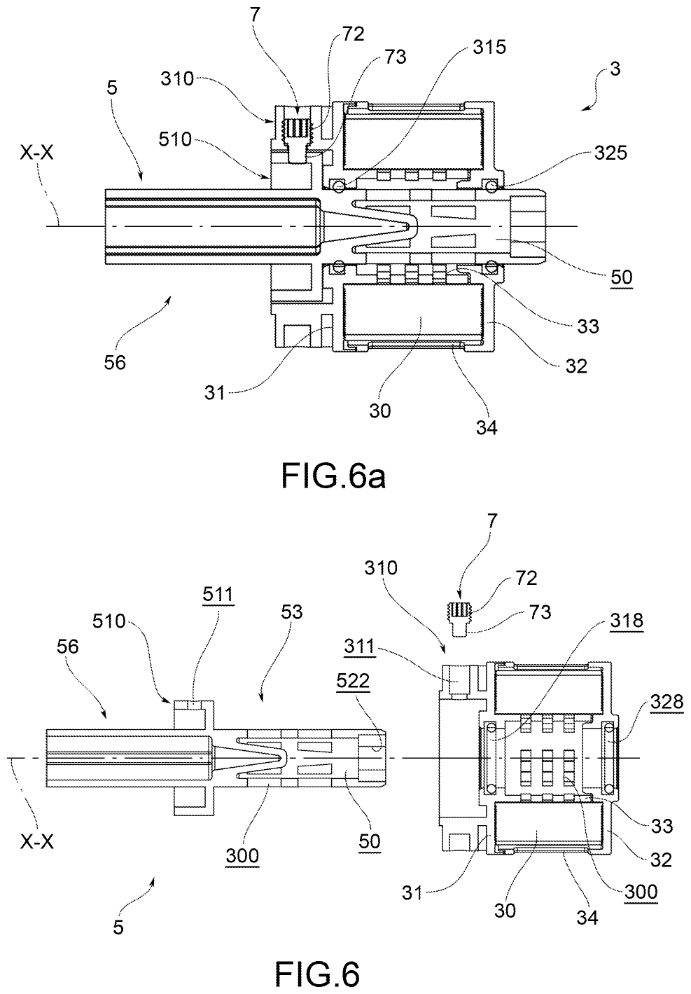

An exemplary embodiment of this type of insert is shown in FIGS. 2, 3 and 3a.

In further other embodiments, the blocking insert 7 is screw blockable, comprising a dedicated threaded insert portion 72 and a blocking portion 73 adjacent thereto.

Preferably, the threaded insert portion 72 is screwable to a threaded wall defining the ring window 311. Preferably, the blocking portion 73 axially adjacent to the threaded insert portion 72 extends in length through the crown window 311.

According to a preferred embodiment, the insert 7 comprises a shoulder between the threaded insert portion 72 and the blocking portion 73. Preferably, the shoulder thus acts as an end stop for screwing the insert. In other words, preferably the shoulder defines the tightening stop of the insert and thus the relative tightening torque.

According to some embodiments, the blow-by gas filtration assembly 1 comprises a plurality of blocking inserts 7 positioned preferably angularly equispaced from each other.

According to a preferred embodiment, the filter group 3 sealingly engages the member 4, preferably the shaft 5, in two axially distinct sealing regions.

Preferably, said two sealing regions are located near the first filter plate 31 and a second filter plate 32.

According to a preferred embodiment, the filter group 3 comprises a first gasket 315 and a second gasket 325 suitable to engage the shaft 5.

According to a preferred embodiment, the shaft 5 comprises air slits 500, axially positioned between the two sealing regions. Said air slits 500 are suitable to place in fluidic communication the air duct 50 and the central chamber 300.

According to a preferred embodiment, there are a plurality of slits 500 and they are positioned mutually angularly equidistant.

As shown in the accompanying drawings, according to a preferred embodiment, the filter portion 53 comprises therein an air duct 50, preferably an outlet of the filtered blow-by gases, in which the outflow of said filtered blow-by gases towards the outlet mouth 22 takes place. In yet other words, the shaft 5 is a hollow body the cavity of which forms at least partially the air duct 50 of the filtered blow-by gases.

In other words, the air duct 50 connects the clean side of the filter group 3 to the outlet mouth 22. In yet other words, the blow-by gases already subjected to filtration operations flow out into the air duct 50.

Preferably, the air duct 50 fluidically connects the central chamber 300 of the filter group 3 to the outlet mouth 22.

According to a preferred embodiment, the filter portion 53 is fluidly connected with the central chamber 300 and the outlet mouth 22 to make the filtered blow-by gases flow out.

Preferably, the shaft 5 comprises a duct outlet 522, which fluidically connects the inside of the air duct 50 and the outlet mouth 22. Preferably, the duct outlet 522 is positioned at an axial end of the shaft 5. Preferably, the duct outlet 522 is positioned at the outlet mouth 22. Preferably, the duct outlet 522 is placed on the shaft 5 at the end of the filter portion 53. Preferably, the duct outlet 522 is positioned on the shaft 5 at the axial end of the filter portion 53 in a distal to the control portion 56. Preferably, the duct outlet 522 is obtained on the control portion 56. Preferably the duct outlet 522 is placed on the shaft 5 at the axial end of the control portion 56. Preferably, the duct outlet 522 is positioned on the control portion 56 of the shaft 5 in an intermediate axial position proximal to the filter group 3.

According to a preferred embodiment, the blow-by gas filtration assembly 1 comprises a first support bearing 8 keyed onto the shaft 5.

According to a preferred embodiment, the blow-by gas filtration assembly 1 comprises a second bearing 9, for support, which can be keyed onto the shaft 5.

Preferably, by means of the first bearing 8 and the second bearing 9 the shaft 5 is positioned along the X-X axis. Preferably, by means of the first bearing 8 and the second bearing 9 the shaft axis 5 is aligned with the X-X axis.

The present invention is not limited to the shape or type of the first and second bearings; preferably, the term “bearing” means a sliding bearing, a ball bearing, or a bushing.

According to a preferred embodiment, the first bearing 8 closes the filtration chamber 20 tight. Preferably, the first support bearing 7 engages the outlet edges 220 defining the outlet mouth 22.

According to a preferred embodiment, the first bearing 8 is positionable on the filter portion 53 in an axial position proximal to the filter group 3 in an axial position distal from the control drive 6.

According to a preferred embodiment, the second bearing 9 is positionable on the control portion 56.

According to a preferred embodiment, the control portion 56 of the shaft 5 is also hollow.

According to a preferred embodiment, the shaft 5 is made of thermoplastic material obtained by means of a single moulding operation.

Preferably, the shaft 5 is made of polyphenylene sulphide (PPS).

Preferably, the shaft 5 is made of a polyphenylene sulphide (PPS) based material.

Preferably, the shaft 5 is made of a polyphenylene sulphide (PPS) based material reinforced with fibreglass (PPS+GF15, PPS+GF30, PPS+GF40).

Preferably, the shaft 5 is made of a nylon-based material (PA, PA 6, PA 6.6 or a mixture thereof).

Preferably, the shaft 5 is made of nylon-based material reinforced with fibreglass. (PA+GF, PA 6.6+GF35, PA 6+PA 6.6+GF 35)

Preferably, the shaft 5 is made of a material comprising a polyamide-based compound (e.g. PPA).

According to a preferred embodiment, the shaft 5 is made of metal. Preferably, the shaft 5 is made of aluminium alloy.

Innovatively, the blow-by gas filtration assembly of the present invention widely fulfils the purpose of the present invention by presenting itself in a simple form and above all requiring simple assembly and disassembly operations.

Advantageously, the engagement between the member and the filter group is certain and safe.

Advantageously, the risk of the member and filter group disengaging from each other, for example due to breakage or malfunction, is substantially obviated.

Advantageously, the member is a multifunctional component. Advantageously, the blow-by gases flow through the support and control member. Advantageously, the filter group is controlled in rotation by means of the support and control member.

Advantageously, the support and control member, in a preferred embodiment, comprises a shaft, hollow or made at least partially in a hollow shape, reducing the weight of the filtration assembly, the consumption associated with the operation of the filtration assembly and the mechanical stresses on the means provided for keeping the filter group in rotation.

Advantageously, the filter group is simple and safe to fit/remove from the member, thus facilitating the assembly and maintenance of the filtration assembly.

Advantageously, the assembly of the filter group and the control member is uniquely achievable, ensuring the installation of original cartridges during periodic maintenance operations of the vehicle.

Advantageously, the engagement between the filter group and the control member is achieved by means of the insert which thus transmits an adequate torque between the control member and the filter group.

Advantageously, the engagement between the filter group is simple and intuitive and allows a reduction of the assembly times of the filtration assembly as well as the maintenance times of the filter.

Advantageously, the respective interface surfaces provided between the filter group and the control member are simple to create/integrate on the respective components, thus reducing the production costs of the assembly and/or filter group.

Advantageously, the insert performs the dual function of blocking the reciprocal axial position between the filter group and the control member and coupling in rotation said components making them mechanically integral to rotate synchronously.

Advantageously, the engagement between the filter group and the control member is realized by means of the insert allowing the interface surfaces between the filter group and the control member to be simplified, thus simplifying the related production equipment (such as the moulds) reducing costs.

It is clear that a person skilled in the art may make modifications to the blow-by gas filtration assembly so as to satisfy contingent requirements, all contained within the scope of protection as defined by the following claims.

### LIST OF REFERENCE NUMBERS

1 blow-by gas filtration assembly
2 main body
20 filtration chamber
21 inlet mouth
22 outlet mouth
220 outlet edge
25 assembly opening
3 filter group
30 filter medium
31 first filter plate
32 second filter plate
310 blocking ring
311 ring window
315, 325 gaskets
318, 328 through openings
33 central structure
34 outer structure
300 central chamber
4 control member
5 shaft
50 air duct
500 air slits
53 filter portion
56 control portion
500 air slits
510 blocking crown
511 crown window
6 control drive
60 electric motor group
61 rotor
62 stator
7 blocking insert
71 elastically yielding teeth
72 insert threaded portion
73 blocking portion
8 first bearing
9 second bearing
10 closing cover
X-X rotation axis

1. A blow-by gas filtration assembly which is fluidically connectable to a crankcase ventilation circuit of an internal combustion engine to receive blow-by gases and filter from suspended particles contained in the blow-by gases, wherein the filtration assembly has an axis and comprises:
a filter group which extends along the axis, having a hollow cylindrical shape with a central cavity which is traversable by blow-by gases radially;
a support and control member engageable to the filter group for supporting the control group in an axial position along the axis and for controlling the filter group in rotation around said axis to perform filtration operations; wherein the member and the filter group respectively comprise a blocking crown and a blocking ring shaped to accommodate each other;
a blocking insert insertable radially with respect to the axis through the blocking crown and the blocking ring to perform reciprocal blocking of the filter group to the member.

2. The blow-by gas filtration assembly according to claim 1, wherein the blocking crown is positioned radially distal to the axis and the blocking ring is positioned in a complementary manner to house said blocking crown.

3. The blow-by gas filtration assembly according to claim 1, wherein the blocking crown comprises a crown window and the blocking ring comprises a ring window through which the blocking insert extends.

4. The blow-by gas filtration assembly according to claim 1, wherein the blocking insert is snap-blockable to the blocking crown and/or in the blocking ring.

5. The blow-by gas filtration assembly according to claim 3, wherein the blocking insert comprises at least two elastically yielding teeth for engaging the crown window walls.

6. The blow-by gas filtration assembly according to claim 1, wherein the blocking insert is screw blockable, comprising a dedicated threaded insert portion and a blocking portion axially adjacent to the threaded insert portion.

7. The blow-by gas filtration assembly according to claim 3, wherein the threaded insert portion is screwable to a threaded wall defining the ring window, wherein the blocking portion extends in length through the crown window.

8. The blow-by gas filtration assembly according to claim 1, comprising a plurality of blocking inserts.

9. The blow-by gas filtration assembly according to claim 1, wherein the support and control member comprises a shaft which extends along the axis, inside the central cavity wherein the shaft comprises a filter portion on which the filter group is mounted and a control portion engaged to a control drive comprised in the member, configured to produce rotatory control action, wherein said blocking crown is on the shaft.

10. The blow-by gas filtration assembly according to claim 9, wherein the filter group sealingly engages the shaft in two distinct axial regions, comprising a first sealing gasket and a second sealing gasket, wherein the shaft comprises air slits that place the air duct and the central chamber axially positioned between the two sealing regions in fluidic communication.

11. The blow-by gas filtration assembly according to claim 1, wherein the filter group comprises a filter medium, a first filter plate and a second filter plate respectively positioned at ends of the filter medium, wherein the blocking ring is made on the first filter plate, on an opposite side to a side engaged by the filter medium.

12. The blow-by gas filtration assembly according to claim 9, wherein the member further comprises a control drive for controlling in rotation the filter group.

13. The blow-by gas filtration assembly according to claim 12, wherein said control drive comprises an electric motor group comprising a rotor and a stator, wherein said rotor is engaged to the control portion of the shaft.

14. The blow-by gas filtration assembly according to claim 1, wherein the central cavity of the filter group is traversable by blow-by gases radially from the outside to the inside;

15. The blow-by gas filtration assembly according to claim 1, wherein said blocking crown is on the filter portion.

16. The blow-by gas filtration assembly according to claim 1, comprising a plurality of blocking inserts positioned angularly equispaced from each other.

17. The blow-by gas filtration assembly according to claim 1, wherein the support and control member comprises a shaft which extends along the axis, inside the central cavity, wherein the shaft comprises a filter portion on which the filter group is mounted and a control portion engaged to a control drive comprised in the member, configured to produce rotatory control action, wherein said blocking crown is on the filter portion.
